(19) United States
(12) Patent Application Publication
(10) Pub. No.: US 2006/0194341 A1
(43) Pub. Date: Aug. 31, 2006

(54) Library of compounds labelled with radiosotope

(76) Inventors: Ronald Colin Garner, York (GB); Graham John Lappin, York (GB)

Correspondence Address: JACOBSON HOLMAN PLLC, 400 SEVENTH STREET N.W., SUITE 600, WASHINGTON, DC, 20004, US

(21) Appl. No.: 10/546,324

(22) PCT Filed: Feb. 27, 2004
(86) PCT No.: PCT/GB04/00825

§ 371 Date: Nov. 17, 2005

(30) Foreign Application Priority Data
Feb. 27, 2003 (GB) 0304433.6

(51) Int. Cl. C40B 40/02; C40B 40/10

(52) U.S. Cl. 436/518

(57) ABSTRACT

Library of compounds or their pharmaceutically acceptable salts, each compound being associated with information on its chemical identity and structure, wherein at least two of the compounds is labelled with radioisotope characterised in that the radioisotope is an AMS active radioisotope; A solid support having a compound or its pharmaceutically acceptable salt as hereindefined bound thereto, the compound being associated with information on its chemical identity and structure and comprising a radioisotope, characterised in that the radioisotope is an AMS active radioisotope as hereinbefore defined; Process for the preparation of a library of compounds as claimed in any of claims 1 to 19 comprising radioisotope labelling a plurality of compounds, each compound being associated with information on its chemical identity and structure characterised in that labelling is with an AMS active radioisotope; A kit therefor; Method for selecting one or more candidate compounds comprising screening a library of the invention comprising AMS active radioisotope labelled compounds as hereinbefore defined and obtaining a sample from the screen or submitting a compound identified for metabolic studies and obtaining a sample therefrom, and performing AMS detection of the sample; and Use of the library, a solid support comprising radioisotope labelled compound or a method as hereinbefore defined in (bio)medical, agrochemical, environmental and like screening for further study by AMS detection.

The present invention relates to a library of compounds labelled with radioisotope for detection of individual compounds, a process for the preparation thereof, a method for selecting from a library a candidate compound displaying desired characteristics and detection thereof in a simultaneous or subsequent study, and the use thereof in compound selection and detection; more particularly the invention relates to a library of compounds labelled with AMS (accelerator mass spectrometry) active radioisotope for detection of individual compounds, a process for the preparation thereof, a method for selecting from a library a candidate compound displaying desired characteristics and detection thereof by AMS; and the use thereof in compound selection, in particular in pharmaceutical drug screening, and AMS detection providing in vivo metabolism characteristics thereof.

The process of drug discovery and development for the pharmaceutical and biotechnology industries involves a host of different activities following initial selection of a number of candidate drugs, Phase 1 studies requiring scale up of drug production, preclinical toxicology, GMP manufacture, animal adsorption, diffusion, metabolism, excretion (ADME) studies etc. Before entering Phase 2 trials as many as one drug in three will have been dropped because of pharmacokinetic (PK), pharmacodynamic or toxicity issues. This process involves enormous cost which is reflected in the high costs of pharmaceuticals brought to market. Moreover the high failure rate of drug candidates further increases the cost of the successful candidates brought to market.

More recently new technologies have been adopted improving speed to market and improving initial drug candidate selection in the hope of improving the success rate during trials. For example selection of a drug may now be made from a larger number of candidates using high throughput screening of candidates in trace amounts. Moreover the candidate drugs screened may be taken from a chemical library comprising hundreds or thousands of analogue chemicals obtained from a combinatorial chemistry approach. The combinatorial chemistry approach has a further advantage in that a large number of compounds may be screened, of which the structures need not be known, the library providing structure information either in the form of a compound tag or compound number. On selection of a number of candidates from the library they are then identified and forwarded for scale up of drug production for the next stage of trials.

In addition Accelerator Mass Spectrometry (AMS) is increasingly replacing the former in vitro techniques used to indicate in vivo metabolism characteristics, giving massive improvements in accurate assessment of in vivo metabolism of compounds. This has led to the development of human microdosing (Human Phase 0) which is a revolutionary new concept which relies on the ultrasensitivity of the AMS technique.

In microdosing one or more drug candidates are taken into humans in trace doses in order to obtain early ADME and PK information. This information is then used as part of the process for selection of suitable drug candidates, to select which of the microdosed drugs has the appropriate PK parameters to take further. The low dose screening ADME studies ensure that drugs do not have to be dropped later down the development pathway because of inappropriate metabolism such as first pass, too short a half life, poor bio-availability etc. Human microdosing dramatically reduces attrition in drug candidate selection at Phase 1 trials.

Using the AMS approach it is however necessary to provide a radio labelled version of a candidate compound, after initial candidate selection by conventional means, and this requires a custom synthesis of radioiosotope labelled candidates. Although microdosing means that synthesis need be only in microdose amounts, the need for custom synthesis and scale up nevertheless provides a bottleneck in the selection method and adds greatly to costs and delays. It is therefore desirable to facilitate this stage to speed up the drug discovery process and reduce costs.

We have now surprisingly found that it is possible to provide an improved libraries comprising compounds labelled with radioisotope for use in candidate compound selection and subsequently determining the fate of the compound by detection thereof, for example detecting by its location on binding or detecting in vivo metabolism characteristics associated with individual library members. This eliminates the need for custom radioisotope labelling of selected candidate drugs at a stage in the selection procedure which effectively brings the entire selection to a halt pending the time consuming synthesis. Moreover the candidate compounds lacking the necessary metabolism characteristics may be eliminated from the drug selection at a much earlier stage dramatically reducing attrition in the selection process.

In the broadest aspect of the invention there is therefore provided a library of compounds or their pharmaceutically acceptable salts, each compound being associated with information on its chemical identity. and structure, wherein at least two of the compounds is labelled with radioisotope characterised in that the radioisotope is an AMS active radioisotope.

AMS is used for the efficient detection of long-lived isotopes at part-per-quadrillion sensitivities, and can analyse ¹⁴C at attomole to zeptomole levels (10⁻¹⁸-10⁻²¹ Moles). AMS performs liquid scintillation counting of radioactive samples of body fluids obtained from a human who has received radioactive doses. One of the most significant advantages of AMS is that it can detect and quantify with relatively short analytical times, levels of radioactivity that are so low that the dose needed to be administered to a human subject falls below the stipulated levels of radioactivity which require regulatory review.

AMS active radioisotopes include any isotopes which are susceptible to AMS analysis. AMS active radioisotopes preferably have low natural backgrounds, for example in the range from 1×10⁻⁵% or less for example to 1×10⁻¹⁵%. The sensitivity of AMS relies on the fact that AMS active radioisotopes have a very low natural background such as 0.00000000001% for ¹⁴C. The background for ¹³C is 1.1%, which by comparison is huge. This means that the incorporation rate for ¹³C would have to be much higher than for ¹⁴C. AMS also generates and analyses negative ions, preferably therefore an AMS active radioisotope is able to form negative ions. Preferably AMS active radioisotopes have long half lives in excess of weeks up to 1,000's of years for ease of handling. Preferably AMS active radioisotopes are non-toxic in AMS active; levels, whereby they are suitable for human metabolism, and preferably are of biomedical interest.

The library of the invention may be envisaged for purpose of detection in screening as hereinbefore defined, and comprise an AMS active radioisotope directly incorporated in the compound as defined or associated with the compound as a tag or the like. Preferably the AMS active radioisotope is incorporated directly in library compounds and is not detachable therefrom, except by degradation of the compound itself, for example by metabolic degradation. A radioisotope is therefore associated by means other than readily hydrolysed linkages or linkages which may be readily cleaved under acidic conditions or the like.

Preferably the radioisotope is covalently incorporated in the compound. More preferably the AMS active radioisotope is present as an atom making up the chemical structure of a library compound, introduced or substituted as the desired radioactive isotope and is not incorporated in a bead or tag associated with the compounds. Most preferably an AMS active radioisotope is present as a cyclic ring atom or heteroatom, preferably an aromatic ring atom or heteroatom, or as an aliphatic carbon chain atom or heteroatom such as a saturated or unsaturated atom or heteroatom, which may be single, double or triple bonded, or the like.

The radioisotope thereby forms an integral part of the compound. It should be appreciate that this is distinct from a radioisotope label applied to a tag such as a support on which a compound is supported, such as a bead, or applied to an identifier tag to provide information on the identity of, or a step in the synthesis of, a given compound. Radioisotope labelled compounds may nevertheless be envisaged for the library of the invention,. in which the radioisotope is present on a tag or other component, which is resilient to metabolic cleavage, and thereby is AMS active.

Preferably the library comprises a plurality of compounds or their pharmaceutically acceptable salts of formula I: 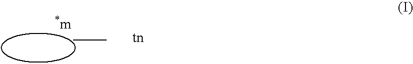
wherein each 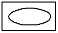
is different and is a compound which comprises an AMS active radioisotope *;
m is a value for the percent incorporation of radioisotope and is fractional in the range from in excess of zero to 1%; and
t is a tag associated with information on the compounds chemical identity and structure wherein n is 0, or a whole number integer.

Preferably m is fractional and is in the range from in excess of zero to 0.1% whereby each compound of formula I is lightly labelled, a proportion thereof having no radioisotope. Different compounds of formula I may comprise same or different radioisotope, and any one compound of formula I may comprise same or different radioisotope present on the same or different molecules. A library is therefore suitably present as a plurality of lightly labelled compounds; or may be present as a plurality of labelled compounds and a corresponding plurality of fully labelled compounds in lesser amount which may be combined to give a lightly labelled compound with appropriate % incorporation, as desired.

Preferably the proportion of radioisotope labelled compounds of any one compound of formula I is such as to provide, in sampling that compound, a sample which is within the limits of AMS detection. Preferably therefore the radioisotope is present in an amount which is within the limits of AMS detection. In a particular advantage the library of the invention relies on the ultrasensitivity of the AMS technology whereby a library of radioisotope labelled compounds may be provided for screening and AMS detection in ultralow quantities or lightly labelled suitable for analysing compounds from the library only in those reactions which can be analysed using the AMS method.

Reference herein to a compound being lightly labelled is to the compound comprising radioisotope present in AMS active amount, preferably corresponding to a value for percent incorporation in a range as hereinbefore defined. Percent incorporation is a measure of maximum specific activity, wherein 100% incorporation is defined as the incorporation of one radioisotope per molecule, taking a given amount of substance, in which every molecule has one specified atom replaced with its radioactive equivalent.

Preferably percent incorporation is in the range 1×10⁻¹² to 0.1%, more preferably 1×10⁻¹⁰ to 0.1%. The library of the invention therefore takes advantage of the analytical power of AMS and the fact that AMS can uniquely be applied to trace radioisotope labelled libraries.

Percent incorporation cannot be derived directly but is calculated from the specific activity of the compound. The maximum specific activity is given in dpm/mmole and is the basic unit of radioactivity—disintegrations per minute—being the number of nuclear disintegrations occurring, on average, every minute. However percent incorporation is a normalised function which can be compared for all radioisotopes, and is more instructive than the term of specific activity which is dependent on radioisotope. For example ¹⁴C as an AMS active radioisotope may be present in a compound of the library of the invention in an amount giving dpm/mmol in the range 5 to 12, preferably 7 to 10, for example in the range 7.3438 to 9.8562 (ANU sucrose). The value for another isotope would be different.

Preferably therefore % incorporation for a given compound is determined by equation Equ 1:

$$\% incorporation ( m ) = \frac{100 \times specific activity}{maximum specific activity} \qquad Equ 1$$

For any radioisotope (based on one radioisotope per molecule, corresponding to 100% incorporation) the maximum specific activity is given by the equation Equ 2:

$$\frac{ln 2}{{t}_{1 / 2}} \times N \qquad Equ 2$$

where ln2 is the natural log of 2(=0.6932)
t_{1/2} is the half-life of the radioisotope in minutes
N is the number of atoms of the radioisotope in 1 mmole (moles compound×6.0225×10²⁰)
(Lappin, G and Garner, R C (2003) Ultra sensitive detection of radiolabelled drugs and their metabolites using Accelerator Mass Spectrometry. Chapter 11 in: Wilson, I D (ed) Bioanalytical Separations Handbook of Separations Vol 4. Elsevier Science BV Amsterdam)

Equation 2 takes no account of diminishing radioactivity (dpm value) due to the half-life of the radioisotope over time (ie it calculates the maximum specific activity at time zero).

The following example calculates the maximum specific activity (based on one radioisotope per molecule) for ¹⁴C. The half-life of ¹⁴C is 5730 years and so any diminishment of radioactivity over short periods of time is negligible. In the following illustration units are as follows:
Bq=Becquerel=60 dpm
kBq: 60×10³ dpm
GBq: 60×10⁹ dpm
kBq/mmole: maximum theoretical specific activity (based on one radioisotope per molecule).
mmole=10⁻³ mole
amole=10⁻¹⁸ mole

From equation Equ 2:

$$\begin{matrix}\frac{0.6932}{( 5730 \times 365.3 \times 24 \times 60 )} \times 6.0225 \times {10}^{ 20} = 1.385 \times {10}^{11} dpm \\ = 2.3083 \times {10}^{6} kBq / mmole\end{matrix}$$

Thus, the maximum theoretical specific activity for ¹⁴C is 2.3083 GBq/mmole, (based on one radioisotope per molecule). This equals 100% incorporation.

Percentage incorporation for lightly labelled compounds according to the present invention is therefore suitably determined by the above equation Equ 1:

Taking a library compound (x22) having specific activity 81.6 dpm/mmol as example:
This is 0.00136 kBq/mmol

If 100% incorporation=2.3083×10⁶ kBq/mmol, then, using Equation 1 above, the % incorporation for compound x22 is 5.8×10⁻⁸%. This very low, level of incorporation is well within the sensitivity of AMS. AMS measures an isotope ratio (¹²C:¹⁴C in the present example). In the case of the analysis of the library compounds, the background level was 1.46 amoles ¹⁴C/mg C. The isotope ratio for compound x22 was 766.49 amoles ¹⁴C/mg C (ie ca 524 times background). This level of sensitivity is more than adequate for many applications such as ligand binding.

It is also feasible to administer library compounds to laboratory animals or humans. A typical human radioactive dose, if AMS is being used as the detection method, is 7.4 kBq. As an example, if the dose of the library compound was 100 mg and the molecular weight was 350, then the specific activity would be 7.4 kBq/0.2857 mmole, or 25.9 kBq/mmole. If 100% incorporation=2.3083×10⁶ kBq/mmole, then 25.9 kBq/mmole=0.001% incorporation.

An AMS active radioisotope may be selected from any radioisotope which is amenable to detection by AMS detection techniques. Radioisotopes vary in half life and thereby in radioactivity and enable detection in smaller or greater amounts whereby certain radioisotopes are particularly suited for certain envisaged applications either by virtue of the chemical nature of the isotope or its radiation characteristics. Many atoms are capable of forming several different radioisotopes, of which certain may be suited for some radiodetection techniques and certain suited for other techniques. Preferably therefore the library specifies the nature of the radioatom and the particular isotope(s) present to indicate suitability of libraries for an intended use. For example a library labelled with ¹²⁹I is useful for AMS detection whereas a library labelled with 131I although highly active is probably of limited use. Similarly a library labelled with ¹⁴C is useful for AMS detection whereas a library labelled with ¹³C is of widespread use in many other radioactive techniques, such as NMR detection, for example as disclosed in WO97/01098, but of no use in AMS analysis. Particularly unsuitable radioisotopes fails to form negative ions, notably radioisotopes of nitrogen.

Compounds in the library of the invention therefore suitably comprise AMS active radioisotopes selected from AMS active radioisotopes of hydrogen, beryllium, carbon, aluminium, phosphorus, chlorine, calcium, manganese, iron, selenium, iodine, barium and lanthanides and actinides such as uranium or plutonium. Preferably a library of the invention comprises compounds radioisotope labelled with an isotope selected from any isotopes that are amenable to AMS analysis, preferably selected from any one or more of ²H, ³, the isotopes of Ba, ¹⁰Be, ¹⁴C, ¹⁷O, ¹⁸O, ²⁶Mg, ²⁶Al, ³²Si, ³⁶Cl, ⁴¹Ca, ⁵⁵Fe, ⁵⁷Fe, ⁶⁰Fe, ⁵³Mn, ⁵⁵Mn, ⁷⁹Se and ¹²⁹I, ²³⁶U, ²³⁹Pu most preferably selected from any one or more of ³H, ¹⁴C and ³⁶Cl.

In a preferred embodiment the invention comprises a library of compounds as hereinbefore defined characterised in that an AMS active radioisotope is a ¹⁴C radioisotope; alternatively or additionally a ³⁶Cl or ³H radioisotope.

A library of compounds according to the invention preferably comprises a plurality of compounds present in solid phase or liquid phase, typically solution phase, or mixtures thereof, each compound supported on a solid support or contained within a sealed vial or the like, as known in the art. Compound supports or carriers such as beads or the like to which the library of compounds and tags have been added facilitate screening of the compounds bound to the bead. Alternatively a library may comprise unsupported compounds, removed from the bead and grouped singly or in a set of 10 to 100 to 1000 or more compounds for screening. A solid phase library may comprise compounds supported on small definable solid supports, commercially available as particles or beads, capillaries, hollow fibers, needles, solid fibers, etc. The solid supports may be non-porous or porous, deformable or hard, and have any convenient structure and shape. In some instances, magnetic or fluorescent beads may be useful. The beads will generally be at least 10-2000 micron, usually at least 20-500 micron, more usually at least 50-250 micron in diameter.

Preferably solid supports which may be employed include cellulose beads, controlled-pore glass beads, silica gel, polystyrene beads, particularly polystyrene beads cross-linked with divinylbenzene, grafted co-polymer beads such as polyethyleneglycol/polystyrene, polyacrylamide beads, latex beads, dimethylacrylamide beads, particularly cross-linked with N,N′-bis-acryloyl ethylene diamine and comprising N-t-butoxycarbonyl-.beta.-alanyl-N′-acryloyl hexamethylene diamine, composites, such as glass particles coated with a hydrophobic polymer such as cross-linked polystyrene or a fluorinated ethylene polymer to which is grafted linear polystyrene; and the like.

In the library of the invention each. compound is associated with information on its chemical identity and structure as hereinbefore defined and as is commonly known in the art of libraries such as combinatorial libraries. Compounds may also be associated with information on the nature of the radioisotope(s) present and the amount, for example the % incorporation or specific activity, thereof. Association may be by means of physical association by means for example of a tag comprising synthesis information or a synthetic memory associated with a bead or solid support on which a compound is (releasably) supported or with which a compound is associated, or may be by numbering or indexing the container or well for, or location of, each compound and providing reference information on the chemical identity and structure of each numbered or indexed compound. Using well plates simplifies mapping of compound identity.

It is known to provide information on chemical identity and structure in a number of ways, including tagging a support, such as a bead, with which a compound in a library is associated, with a radioisotope. Such tags are however designed to be readily cleaved in order to perform assays unsupported or to read the synthesis information. It should be appreciated that the present invention is distinct in that radioisotope of the library of the invention is present as an integral part of each library compound and is not detachable therefrom, for example if not an integral part of a library compound structure is associated with a pharmaceutically compatible tag which is irreversibly associated with the compound to the degree that dissociation takes place only on degradation of the compound itself, for example by metabolic degradation. A radioisotope is therefore associated by means other than readily hydrolysed linkages or linkages which may be readily cleaved under acidic conditions or the like.

Preferably the library of compounds is provided as an array of compounds suitable for use in high throughput screening and the like. An array may comprise a plate such as a microtiter plate, cell array, vial or bottle array, support matrix or plate, fibre optic array or the like as known in the art of combinatorial chemistry or may comprise a plurality of supports or containers such as vials, bottles or the like wherein support or container or compound is labelled with an identifier or tag which identifies the compound as a component of a library of compounds or which identifies the compound by chemical identity and structure. A library comprising compounds present on solid support(s) such as beads may in some cases provide an advantage in terms of ease of preparation and accuracy of detection in that unincorporated radioisotope from the synthesis remaining in the reaction mix may be simply washed away avoiding any contamination in use of the library or exceeding % incorporation levels as hereinbefore defined.

The purpose of the compound tags is for decoding the reaction history of the compound. The product may then be produced in a large synthesis. Where the reaction history unequivocally defines the structure, the same or analogous reaction series may be used to produce the product in a large batch. Where the reaction history does not unambiguously define the structure, one would repeat the reaction history in a large batch and use the resulting product for structural analysis. In some instances it may be found that the reaction series of the combinatorial chemistry may not be the preferred way to produce the product in large amounts.

In the library and method of the invention a tag may be retained with or separated from the compound for AMS study; and may be decoded prior to AMS detection but is preferably not decoded until the AMS results indicate that it is selected as a candidate for further trials.

Compounds present in the library may be present in any desired amount. In a particular advantage the library of the invention comprises compounds in small quantities of nanomoles or millimoles, typically milligrams, by virtue of the sensitivity of AMS detection techniques, up to moles or grams. Suitably compounds are present in same or different amounts in the range of 0.1 microgram to 10 g, preferably 1 microgram to 100mg, for example 10 microgram to 10 mg. This has a double cost advantage, since the conventional unlabelled library is typically not cheap, and isotopes are also not cheap, whereby radioisotope labelling of compounds in small amounts helps to limit the cost of the library. In the preferred embodiment of the invention as hereinbefore defined the AMS active library provides a means to reduce the quantities of compounds present in a compound library by the adoption of the AMS detection technique, thereby reducing cost.

The library of the invention may comprise any desired number of compounds. Commonly libraries are provided wherein from 20 to millions of compounds are present. Preferably the library of. the invention comprises from 5 to 5×10⁶ compounds, for example from 20 to 1,000,000 for example greater than 25,000 or greater than 50,000 compounds, such as greater than 200,000 compounds. Particular advantages are associated with larger libraries of in excess of 25,000 compounds, since the benefits of directly subjecting selected compounds from the library to radiodetection techniques increase with the number of compounds to be detected. On the other hand the cost of a library increases with the number of compounds in the library and therefore there are advantages associated with smaller libraries of from 20 to 25,000 compounds.

In one embodiment all or substantially all compounds in the library comprise an amount of radioisotope as hereinbefore defined. Compounds may comprise the same or different radioisotope. Preferably therefore the library comprises compounds as hereinbefore defined associated with information on the radioisotope identity or identities of each individual library member, for example to enable correct AMS sample preparation, in view of the different sample preparation techniques required for each type of radioisotope in AMS.

In an alternative embodiment a proportion of the compounds in the library comprise a radioisotope. This may be of advantage in the case of a method for screening a library for a first selection of candidate compounds providing a desired activity, reactivity, functionality or the like, in which the method includes making a secondary selection from those compounds identifying as positive in terms of activity, reactivity, functionality or the like, and forwarding the secondary selection for radiodetection in a microdosing technique as hereinbefore and hereinbelow defined. In the alternative embodiment of the invention the secondary selection would simply be to select those compounds which show best activity and which comprise a radioisotope.

Suitably at least 40% of the compounds are lightly labelled, preferably at least 50% of the compounds are lightly labelled, more preferably at least 75% of the compounds are lightly labelled, more preferably at least 90% of the compounds are lightly labelled, most preferably all or substantially all of the compounds are lightly labelled.

A compound of the library of the invention may comprise more than one radioisotope which may be the same or different, and are preferably different. In the method of microdosing and AMS detection as hereinbefore defined it is common for compounds to be metabolised in vivo and indeed it is this metabolic data which is sought in the method. Preferably therefore the library of the invention comprises a plurality of compounds having a plurality of radioisotopes introduced randomly or specifically in different moieties of the compound, whereby the metabolic pathway for potentially active and potentially inert moieties may be monitored giving more comprehensive metabolic information on the target delivery sites of active and inert moieties.

The library may be structurally diverse or similar and is suitably a chemical or a biochemical library. Preferably in one embodiment the library comprises organic compounds which are not amenable to biochemical synthesis, ie synthetically obtained non-biochemical compounds. In an alternative embodiment the library may comprise biochemical compounds made up of individual units such as amino acids, peptides, nucleic acids, fatty acids, carbohydrates etc. However particular advantages are obtained with libraries other than peptides and oligonucleotides.

The library may be a combinatorial library comprising compounds which are analogues of a common structure obtained from a combinatorial synthesis or biosynthesis; or dissimilar compounds having common reactive functionality suitable for targetting a particular reaction or mechanism, or may be structurally diverse compounds providing multiple structure types or reactive functionality suitable for targetting or probing an unknown reaction or mechanism type.

Preferably the library of the invention comprises a plurality of small molecules, typically naturally occurring or synthetic chemical or biochemical bioactive molecules and their analogues for example of up to 1000 MW. Alternatively the library comprises a plurality of larger molecules, typically naturally occurring or synthetic biomolecules and their analogues, such as radioisotope labelled biopolymers including radioisotope labelled recombinant proteins such as insulin analogues, growth hormone analogues, antibodies and the like, peptides, plant or gene therapy products.

In a further aspect of the invention there is provided a solid support having a compound or its pharmaceutically acceptable salt bound thereto, the compound being associated with information on its chemical identity and structure and comprising a radioisotope, characterised in that the radioisotope is an AMS active radioisotope as hereinbefore defined.

A solid support is suitably any solid support as known in the art of chemical libraries as hereinbefore defined, and is preferably associated with information on its chemical identity and structure as hereinbefore defined. Preferably the solid support is characterised by further features as hereinbefore and hereinbelow defined in respect of a library of the invention.

In a further aspect of the invention there is provided a process for the preparation of a library of compounds as hereinbefore defined comprising radioisotope labelling a plurality of compounds, each compound being associated with information on its chemical identity and structure characterised in that labelling is with an AMS active radioisotope.

The process may be a process for preparation of a solution phase or solid phase library of compounds, unsupported or supported using techniques as known in the art. Preferably labelling is performed in manner to provide further features of a library as hereinbefore defined.

Labelling may be conducted as part of any known single or multistep synthetic route or biosynthesis, or may be conducted as a dedicated chemical or biosynthetic labelling step on commercially available or previously synthesised compounds, or a mixture thereof. Radioisotope labelling is suitably performed by techniques as known in the art for labelling compounds. A biosynthesis is suitably performed by culturing a microrganism which produces biochemical products in a radioisotope enriched environment and harvesting labelled products. Preferably the enriched environment comprises an AMS active radioisotope as hereinbefore defined, preferably in AMS active amount as hereinbefore defined. Biochemical components or metabolites or microorganisms become labelled as a result of growing the microorganism in the enriched environment as known in the art.

Preferably the process comprises lightly labelling a synthetic precursor or intermediate or a biochemical culture substrate and reacting with other precursors or intermediates, or culturing a microrganism therein whereby the radioisotope is incorporated in the synthesis or biosynthesis product. It is not always possible to control the percent incorporation of a radioisotope in a compound, or in this case in a precursor, intermediate or culture substrate, whereby. Preferably therefore the process comprises labelling a synthetic precursor or intermediate or a biochemical culture substrate, determining the specific activity thereof, determining the desired specific activity to give a desired percent incorporation, and combining with a sufficient amount of corresponding unlabeled synthetic precursor or intermediate or a biochemical culture substrate and isolating as a homogeneous product having desired percent incorporation. Preferably isolating a homogeneous product is by recrystallisation of the combined labelled and unlabelled product.

Thereafter the synthesis or biosynthesis process using the lightly labelled precursor or intermediate or biochemical culture substrate incorporates radioisotope in desired percent incorporation.

Processes and techniques are available for performing gram or milligram scale scale custom syntheses of radioisotope labelled compounds. It is within the expertise of the skilled person to combine such custom synthetic processes and techniques with combinatorial techniques to provide combinatorial radioisotope syntheses.

Methods for preparing combinatorial libraries are known in the art and include the techniques of parallel or series synthesis, split pool or split and mix synthesis whereby intermediates are split for diverse reactions and mixed for common reactions, and the like. Synthesis may be carried out in dedicated combinatorial reactors such as multi-reactor synthesisers, or in conventional manner.

Radioisotope labelled combinatorial methods may therefore be envisaged in which a core molecule is radioisotope labelled, preferably lightly labelled as hereinbefore defined, and split into a plurality of samples, each of which is then subject to combinatorial variation, by reaction with a known or random, structured or diverse, collection of derivatisation reagents in one or more stages to provide a library of radioisotope labelled derivatives. Alternatively a core molecule may be split into a plurality of samples, each of which is then subject to combinatorial variation, by reaction with a known or random collection of, preferably lightly, radioisotope labelled derivatisation reagents in one or more stages to provide a library of, preferably lightly, radioisotope labelled derivatives.

Compounds of the library of the invention may be obtained from reactions involving modifications at a variety of random sites of a central core molecular structure or modifications at a specific site, as known in the art. For example, one may brominate a polycyclic compound, where bromination may occur at a plurality of sites or use a brominating agent which will be specific for a particular site, e.g., N-bromosuccinimide. For the most part, reactions will involve single sites or equivalent sites, for example, one of two hydroxyl groups of a glycol.

For the most part, compounds of the library of the invention may be obtained from a synthesis having at least two stages where other than bifunctional compounds are attached using the same linking functionality, e.g. amino acids and amide bonds, nucleotides and phosphate ester bonds, or mimetic compounds thereof, e.g., aminoiso-cyanates and urea bonds. Preferably the process comprises serial synthesis involving the addition or removal of chemical units, reactions involving the modification or introduction of one or more functionalities, ring openings, ring closings, etc. Chemical units can take many forms, both naturally-occurring and synthetic, such as nucleophiles, electrophiles, dienes, alkylating or acylating agents, diamines, nucleotides, amino acids, sugars, lipids, or derivatives thereof, organic monomers, synthons, and combinations thereof. Alternatively, reactions may be involved which result in alkylation, acylation, nitration, halogenation, oxidation, reduction, hydrolysis, substitution, elimination, addition, and the like. Compounds may be non-oligomers, oligomers, or combinations thereof in extremely small amounts, where the reaction history, and composition in appropriate cases, can be defined by the tags as known in the art. Non-oligomers include a wide variety of organic molecules, e.g. heterocyclics, aromatics, alicyclics, aliphatics and combinations thereof, comprising steroids; antibiotics, enzyme inhibitors, ligands, hormones, drugs, alkaloids, opioids, terpenes, porphyrins, toxins, catalysts, as well as combinations thereof. Oligomers include oligopeptides, oligonucleotides, oligosaccharides, polylipids, polyesters, polyamides, polyurethanes, polyureas, polyethers, poly (phosphorus derivatives) e.g. phosphates, phosphonates, phosphoramides, phosphonamides, phosphites, phosphinamides, etc., poly (sulfur derivatives) e.g. sulfones, sulfonates, sulfites, sulfonamides, sulfenamides, etc., where for the phosphorous and sulfur derivatives the indicated heteroatom for the most part will be bonded to C, H, N, O or S. and combinations thereof.

Known combinatorial synthetic methods permit variation in reaction at each stage, depending on the choice of agents and conditions involved. Thus, for amino acids, one may have up to 20 amino acids involved using the common naturally-encoded amino acids and a much wider choice, if one wishes to use other amino acids, such as D-amino acids, amino acids having the amino group at other than the alpha-position, amino acids having different substituents on the side chain or substituents on the amino group, and the like. For the different nucleic acids, there will usually be up to 4 natural nucleic acids used for either DNA or RNA and a much larger number is available if one does not choose to use those particular nucleic acids. For the sugars and lipids, there are a very large number of different compounds, which compounds may be further increased by various substitutions, where all of these compounds may be used in the synthesis. For individual organic compounds the choice may be astronomically large. In addition, one may have mimetic analogues, where ureas, urethanes, carbonylmethylene groups, and the like may substitute for the peptide linkage; various organic and inorganic groups may substitute for the phosphate linkage; and nitrogen or sulfur may substitute for oxygen in an ether linkage or vice versa.

The library of the invention may be obtained by a synthetic strategy which varies with the nature of the group of products one wishes to produce. Thus, the strategy must take into consideration the ability to stage-wise change the nature of the product, while allowing for retention of the results of the previous stages and anticipating needs for the future stages. Where the various units are of the same family, such as nucleotides, amino acids and sugars, the synthetic strategies are relatively well-established and frequently conventional chemistry will be available. Thus, for nucleotides, phosphoramidite or phosphite chemistries may be employed; for oligopeptides, Fmoc or Boc chemistries may be employed where conventional protective groups are used; for sugars, the strategies may be less conventional, but a large number of protective groups, reactive functionalities, and conditions have been established for the synthesis of polysaccharides. For other types of chemistries, one will look to the nature of the individual unit and either synthetic opportunities will be known or will be devised, as appropriate.

In some instances, a library of the invention may comprise compounds having the same or different blocks introduced at the same or different stages in the synthesis. For example, one may wish to have a common peptide functional unit, e.g. the fibronectin binding unit (RGDS), a polysaccharide, e.g. Lex, an organic group, e.g. a lactam, lactone, benzene ring, olefin, glycol, thioether, etc. introduced during the synthesis. In this manner one may achieve a molecular context into which the variation is introduced. These situations may involve only a few stages having the plurality of choices, where a large number of products are produced in relation to a particular functional entity. This could have particular application where one is interested in a large number of derivatives related to a core molecule or unit known to have a characteristic of interest.

In one embodiment the library of the invention is preferably obtained by batch synthesis of a few compounds which would be prepared during the course of the combinatorial synthesis. By taking extreme examples, for example, syntheses which might involve steric hindrance, charge and/or dipole interactions, alternative reaction pathways, or the like, one can optimise conditions to provide for enhanced yields of compounds which might not otherwise be formed or be formed only in low yield. In this manner, one may allow for a variety of reaction conditions during the combinatorial synthesis, involving differences in solvent, temperatures, times, concentrations, and the like. Furthermore, one may use the batch syntheses, which will provide much higher concentrations of particular products than the combinatorial synthesis, to develop assays to characterise the activity of the compounds.

Preferably the method comprises the synthesis of a single or mixed solution-phase/solid-phase lightly labelled library. incorporating trace levels of ¹⁴C lightly radioisotope labelled precursor. Preferably precursors are core labelled not substituent labelled, for example lightly ring labelled benzoic acid.

Preferably the method comprises a 2 to 6 component condensation, substitution or the like reaction as hereinbefore defined, for example a four-component condensation such as an Ugi reaction ((a) Cao, X; Moran, E. J.; Siev, D.; Lio, A.; Ohashi, C.; Mjalli, A. M. M. Bioorg. & Med. Chem. Lett., 1995, 5, 2953-2958 and (b) Nakamura, M.; Inoue, J.; Yamada, T. Bioorg. & Med. Chem. Lett., 2000, 10, 2807-2810). This condenses a carboxylic acid, amine, aldehyde and isocyanide to form a substituted alpha (acylamino) amide. In Scheme 1 and 2, any one or more of the four components may be lightly labelled, with the same or different AMS active radioisotope.

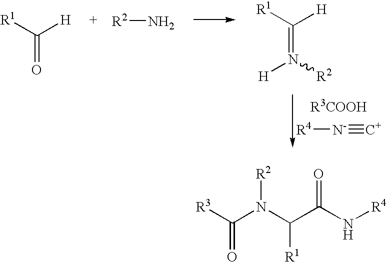

For a solid-phase library preferably a solid-supported precursor is used eg an amine (scheme 2).

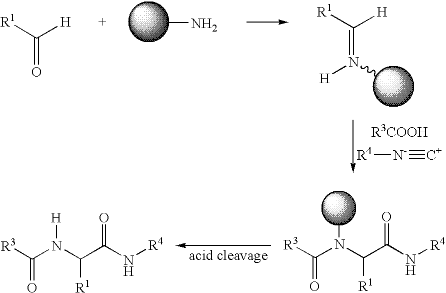

Test runs may be undertaken on representative library members using unlabelled (‘cold’) precursor, eg benzoic acid. The results indicate library members containing benzaldehyde as a building block that cannot be synthesised and as such these may be removed from the library.

A biochemical library is conveniently prepared by growing microorganisms in an AMS active radioisotope enriched environment as hereinbefore defined. Known techniques include growth of bacteria or yeast in the presence of labelled carbohydrate and salts, or in labelled methanol, or in labelled algal lysates, phototrophic culture of algae in labelled CO₂, growth of mammalian or insect cells in labelled media, and the like. Any components of the microorganism can be harvested as lightly labelled precursor or library compound, for example amino acids, fatty acids, carbohydrates, nucleic acids etc.

Preferably microorganisms are grown in lightly radioisotope labelled culture such as ¹⁴C glucose, and encouraged to mutagenise forming mutated bacteria, plated and cultured to form colonies generating secondary metabolites which are radioisotope labelled, and metabolites are harvested providing a library of the invention. Harvesting may be by disrupting the culture and lysing the bacteria, or by lifting off excreted metabolites.

The library of the invention may be provided on any known support typical of libraries as known in the art as hereinbefore defined which can be readily mixed, separated, and serve as a solid substrate for the sequential synthesis. Depending upon the nature of the synthesis, the beads may be functionalised in a variety of ways to allow for attachment of the initial reactant. These may be linked through a non-labile linkage such as an ester bond, amide bond, amine bond, ether bond, or through a sulfur, silicon, or carbon atom, depending upon whether one wishes to be able to remove the product from the bead. Conveniently, the bond to the bead may be permanent, but a linker between the bead and the product may be provided which is cleavable such as exemplified in Table 1. Two or more different linkages may be employed to allow for differential release of tags and/or products.

Depending upon the nature of the linking group bound to the particle, reactive functionalities on the bead may not be necessary where the manner of linking allows for insertion into single or double bonds, such as is available with carbenes and nitrenes or other highly-reactive species. In this case, the cleavable linkage will be provided in the linking group which joins the product or the tag to the bead.

Desirably, when the product is permanently attached, the link to the bead will be extended, so that the bead will not sterically interfere with the binding of the product during screening. Various links may be employed, particular hydrophilic links, such as polyethyleneoxy, saccharide, polyol, esters, amides, combinations thereof, and the like.

Functionalities present on the bead may include hydroxy, carboxy, iminohalide, amino, thio, active halogen (Cl or Br) or pseudohalogen (e.g., —CF₃, —CN, etc.), carbonyl, silyl, tosyl, mesylates, brosylates, triflates or the like. In selecting the functionality, some consideration should be given to the fact that the identifiers will usually also become bound to the bead. Consideration will include whether the same or a different functionality should be associated with the product and the identifier, as well as whether the two functionalities will be compatible with the product or identifier attachment and tag detachment stages, as appropriate. Different linking groups may be employed for the product, so that a specific quantity of the product may be selectively released. In some instances the particle may have protected functionalities which may be partially or wholly deprotected prior to each stage, and in the latter case, reprotected. For example, amino may be protected with a carbobenzoxy group as in polypeptide synthesis, hydroxy with a benzyl ether, etc.

Tags may be released from the library compound, and then subjected to a detecting means for example reacting with a molecule which allows for detection. Such tags may be quite simple, having the same functionality for linking to the library compound as to the detecting means. For example, by being linked to a hydroxycarboxyl group, a hydroxyl group would be released, which could then be esterified or etherified with the molecule which allows for detection. For example, by using combinations of fluoro- and chloroalkyl groups, in the binary mode, the number of fluoro and/or chloro groups could determine choice, while the number of carbon atoms would indicate stage. Preferably the library of the invention comprises compounds having detachable tags, for which there are numerous functionalities and reactants known in the art. Conveniently, ethers may be used, where substituted benzyl ether or derivatives thereof, e.g. benzhydryl ether, indanyl ether, etc. may be cleaved by acidic or mild reductive conditions. Alternatively, one may employ beta-elimination, where a mild base may serve to release the product. Acetals, including the thio analogues thereof, may be employed, where mild acid, particularly in the presence of a capturing carbonyl compound, may serve. By combining formaldehyde, HCl and an alcohol moiety, an .alpha.-chloroether is formed. This may then be coupled with an hydroxy functionality on the bead to form the acetal. Various photolabile linkages may be employed, such as o-nitrobenzyl, 7-nitroindanyl, 2-nitrobenzhydryl ethers or esters, etc. Esters and amides may serve as linkers, where half-acid esters or amides are formed, particularly with cyclic anhydrides, followed by reaction with hydroxyl or amino functionalities on the bead, using a coupling agent such as a carbodiimide. Peptides may be used as linkers, where the sequence is subject to enzymatic hydrolysis, particularly where the enzyme recognises a specific sequence. Carbonates and carbamates may be prepared using carbonic acid derivatives, e.g. phosgene, carbonyl diimidazole, etc. and a mild base. The link may be cleaved using acid, base or a strong reductant, e.g., LiAlH₄, particularly for the carbonate esters.

In a further aspect of the invention there is provided a kit for preparing a library of the invention as hereinbefore defined, with the method of the invention as hereinbefore defined, comprising one or more sets of a plurality of separated reactants, and optionally an amount of one or more common reactants to be reacted with each set, each of the reactants characterised by having a distinguishable composition, being associated with information on structure or identity, and sharing at least one common functionality, at least one set or one common reactant being labelled with an AMS active radioisotope as hereinbefore defined.

A kit may provide various reagents for use as tags in carrying out the library syntheses. Reagents for use as tags may comprise at least 4, usually 5, different compounds in separate containers, more usually at least 10, and not more than about 100, more usually not more than about 36 different separated organic compounds. For binary determinations, the mode of detection will usually be common to the compounds associated with the analysis, so that there may be a common chromophore, a common atom for detection, etc. Where each of the identifiers is pre-prepared, each will be characterised by having a distinguishable composition encoding choice and stage which can be determined by a physical measurement and including groups or all of the compounds sharing at least one common functionality.

Alternatively, the kit may provide reactants which can be combined to provide the various identifiers or tags. Reactants may comprise a plurality of separated first functional, frequently bifunctional, organic compounds, usually four or more, generally one for each stage of the synthesis, where the functional organic compounds share the same functionality and are distinguishable as to at least one determinable characteristic. In addition, the kit may comprise at least one, usually at least two, second organic compounds capable of reacting with a functionality of the functional organic compounds and capable of forming mixtures which are distinguishable as to the amount of each of the second organic compounds. For example, reagents may comprise a glycol, amino acid, or a glycolic acid, where the various bifunctional compounds are distinguished by the number of fluorine or chlorine atoms present, to define stage, and have an iodomethane, where one iodomethane has no radioisotope, another has ¹⁴C and another has one or more ³H. By using two or more of the iodomethanes, one could provide a variety of mixtures which could be determined by their radioemissions. Alternatively, one could have a plurality of second organic compounds, which could be used in a binary code.

In a further aspect of the invention there is provided a method for selecting one or more candidate compounds for medical applications, comprising screening a library of the invention comprising AMS active radioisotope labelled compounds as hereinbefore and obtaining a sample from the screen or submitting a compound identified for metabolic studies and obtaining a sample therefrom, and performing AMS detection of the sample. Screening may be for a desired activity, reactivity, inhibition, functionality or the like, as known in the art, identifying one or more candidate radioisotope labelled compounds from the library. AMS detection is suitably conducted on a screening sample or by dosing, for example microdosing, the candidate radioisotope labelled compounds in human, animal or plant subjects and performing AMS detection of metabolic samples taken from the subjects. A sample is preferably prepared for AMS from any sample which is derived from a screen, such as a cell or cell membrane sample, or from human, animal or plant derived dosing samples, such as tissues or cells, bodily fluids such as blood or urine, faeces, plant tissues, soil or soil organisms such as worms and the like.

The method of the invention is therefor useful both in providing for in vitro activity, reactivity, inhibition or functionality screening and selection of compounds and in providing binding or in vivo metabolic data for the selected candidate compounds, in particular for providing ADME and PK data.

Screening is performed in known manner by taking a sample of each compound present in the library and subjecting to a desired assay.

Screening may be with any known or novel medical, biological, environmental or like screen and is typically a human or animal biomedical assay or the like, for example a protein binding assay, such as a receptor binding assay.

A wide variety of assays and techniques are commercially available to determine a characteristic of interest of a screened compound.

Screening may be conducted on compounds associated directly with their identifiers, such as beads as hereinbefore defined, and may be conducted on single beads or groups of compounds to determine whether the compound or groups show activity. Groups may involve 10, 100, 1000 or more compounds. In this way, large groups of compounds may be rapidly screened and segregated into smaller groups of compounds.

A common screen is to detect binding to a particular biomolecule such as a receptor. The receptor may be a single molecule, a molecule associated with a microsome or cell, or the like. Where agonist activity is of interest, one may wish to use an intact organism or cell, where the response to the binding of the subject product may be measured. In some instances, it may be desirable to detach the compound from the bead, particularly where physiological activity by transduction of a signal is of interest. Where binding is of interest, one may use a labeled receptor where the label is a fluorescer, enzyme, radioisotope, or the like, where one can detect the binding of the receptor to the compound on the bead. Alternatively, one may provide for an antibody to the receptor, where the antibody is labeled, which may allow for amplification of the signal and avoid changing the receptor of interest, which might affect its binding to the product of interest. Binding may also be determined by displacement of a ligand bound to the receptor, where the ligand is labeled with a detectable label.

A screen may comprise a two-stage screen, comprising binding as an initial screen, followed by biological activity with a viable cell in a second screen. Using recombinant techniques to prepare libraries allows great variation in the genetic capability of cells. One can then produce exogenous genes or exogenous transcriptional regulatory sequences, so that binding of gene or sequence to a surface membrane protein will result in an observable signal, e.g. an intracellular signal. For example, a second screen may comprise introducing a leuco dye into the cell, where an enzyme which transforms the leuco dye to a colored product, particularly a fluorescent product, becomes expressed upon appropriate binding to a surface membrane, e.g. beta-galactosidase and digalactosidylfluorescein. In this manner, by associating a particular cell or cells with a particular candidate compound, the fluorescent nature of the cell may be determined using a FACS, so that active candidate compounds may be identified. Various techniques may be employed to ensure that the candidate compound remains bound to the cell, even where the product is released from the candidate compound. For example, the compound may comprise antibodies to a surface membrane protein, eg one may link avidin to the surface of the cell and have biotin linked to the candidate compound directly or via its carrier or bead, etc.

Assays may be performed stagewise using individual compounds or groups of compounds or combinations thereof. For example, after carrying out the combinatorial syntheses, groups of about 50 to 10,000 compounds may be segregated in separate vessels. In each vessel a portion of the each compound is released, if bound to a carrier. The fractional release may be as a result of differential linking of the product to the particle or using a limited amount of a reagent, condition or the like, so that the average number of compound molecules released per carrier is less than the total number of compound molecules per carrier. The screen media then comprises a mixture of compounds in a small volume. The mixture could then be used in an assay for binding, where the binding event could be inhibition of a known binding ligand binding to a receptor, activation or inhibition of a metabolic process of a cell, or the like. Various assay conditions may be used for the detection of binding activity as known in the art. Once a group is shown to be active, the individual compounds may then be screened, by the same or a different assay, giving a three- or four-stage procedure in total, where large groups are divided up into smaller groups, etc. and finally single compounds are screened. In each case, portions of the compounds on carriers would be released and the resulting mixture used in an appropriate assay. Assays may be the same or different, the more sophisticated and time consuming assays being used in the later or last stage.

Screening may alternatively be performed on spatial arrays, whereby compounds may be distributed over a honeycomb plate, with each well in the honeycomb having 0 or 1 compound.

Screening may be used to identify compounds with catalytic properties, such as hydrolytic activity, e.g. esterase activity. In a catalytic screen compounds may be embedded in a semisolid matrix surrounded by diffusible test substrates. If the catalytic activity can be detected locally by processes that do not disturb the matrix, for example, by changes in the absorption of light or by detection of fluorescence due to a cleaved substrate, compounds in the zone of catalytic activity can be isolated and their identifier tags decoded.

Screening may be used to identify compounds with inhibitory or activating activity. Compounds may be sought that inhibit or activate an enzyme or block a binding reaction. To detect compounds that inhibit an enzyme compounds are suitably released from carriers enabling them to diffuse into a semisolid matrix or onto a filter where this inhibition, activation or blocking can be observed. Compounds that form a visualised or otherwise detectable zone of inhibition, activation or blocking can then be picked and the tags decoded.

Tagging in this case is preferably by attached to the compounds by cleavable linkages, preferably a photolabile linkage, while a portion of the tags remain attached to the bead, releasable after picking by a different means than before.

A dialysis membrane may be employed where a layer of supported compounds is separated from a layer of radioisotope labeled ligand/receptor pair. The compound layer may be irradiated with ultraviolet light releasing the compound which would diffuse to the pair layer, where the radioisotope labelled ligand would be released in proportion to the affinity of the compound for the receptor. The radioisotope labelled ligand would diffuse back to the layer of compounds. Since the radioisotope would be proximal to the compound, compounds associated with radioemission would be analysed.

A screen may be used to identify compounds having biological activity. In some applications it is desirable to find a compound that has an effect on living cells, such as inhibition of microbial growth, inhibition of viral growth, inhibition of gene expression or activation of gene expression. Screening of supported compounds may be achieved, for example, by embedding the supports in a semisolid medium and the library of compounds released from the embedded supports enabling the compounds to diffuse into the surrounding medium. The effects, such as plaques within a bacterial lawn, can be observed. Zones of growth inhibition or growth activation or effects on gene expression can then be visualised and compounds at the centre of the zone picked and analysed.

A screen may include gels where the molecule or system, e.g. cell, to be acted upon may be embedded substantially homogeneously in the gel. Various gelling agents may be used such as polyacrylamide, agarose, gelatin, etc. Compounds may then be spread over the gel so as to have sufficient separation between the compounds to allow for individual detection. If the desired compound is to have hydrolytic activity, a substrate may be present in the gel which would provide a fluorescent product, enabling screening the gel for fluorescence and mechanically selecting compounds associated with the fluorescent signal.

Cells may be embedded in the gel, in effect creating a cellular lawn. Compounds may be spread out as described above. Techniques are known in the art for placing a grid over a gel defining areas of one or no compound. Cytotoxicity may be detected by releasing a library compound, incubating for a sufficient time, followed by spreading a vital dye over the gel. Those cells which absorbed the dye or did not absorb the dye could then be distinguished.

As known in the art cells can be genetically engineered so as to indicate when a signal has been transduced. There are many receptors for which the genes are known whose expression is activated. By inserting an exogenous gene into a site where the gene is under the transcriptional control of the promoter responsive to such receptor, an enzyme can be produced which provides a detectable signal, e.g. a fluorescent signal. A library compound associated with the fluorescent cell(s) may then be analysed for its reaction history.

The method of the invention includes selecting one or more compounds, for example 5 to 100 compounds in a successful screen, providing a radioisotope labelled sample of the selected compounds from the library of the invention and forwarding for radiodetection in a subsequent study, for example for AMS detection in a metabolic, pharmacokinetic or like study.

AMS microdosing is suitably by administering an amount of candidate compound alone or with a suitable carrier to a human or animal subject. Administration is typically by oral, dermal, buccal, vaginal, anal, subcutaneous, nasal route or by inhalation. A microdose suitably comprises sufficient compound to give a low dose of the order of nanocuries of radioactive label, for example is of the order of ng or mg. Preferably a microdose comprises 1-5 nanoCuries, more preferably is less than 1 microSievert, thereby being exempt from regulatory approval. A microdose may therefore comprise from 1 microgram to 1 milligram, preferably 1 microgram to 500 micrograms of radioisotope labelled compound of the library of the invention.

After a period of days, weeks or months, samples are taken of tissue or cells, blood samples, urine or faeces. Samples are suitably taken at intervals in order to detect compound metabolism rate and indicate rapid and slowly metabolised compounds. The method is described in WO 01/59476, the contents of which are incorporated herein by reference.

Analysis of AMS results indicates number of isotope counts, eg of ¹⁴C, ratio of modern (ie naturally occurring) isotopes and percent modern isotope as a combination of the number of counts and the ratio of modern isotope. pMC (percent modern carbon) is an AMS term of radioactivity and provides a measure of the carbon content of a sample. pMC=Times modern×100. One times modern=¹⁴C/¹²C ratio in the atmosphere in 1952. The ratio ¹²C/¹³C remains relatively constant.

In the method of the invention a sample is prepared for AMS analysis in a range of micrograms or less of tissues or cells to a few microlitres of blood or urine. Samples may also comprise plant tissues, soil or soil organisms such as worms, as known in the art.

The sample is prepared in a form that can yield negative ions within the instruments ion source, as known in the art. Sample preparation may be by traditional methods which prepare thermally and electrically conductive solids, are non fractionating, efficient and protected from contamination by isobars or unexpected concentrations of the rare isotope in or on laboratory equipment. Uniformity and comparability between samples and standards are ensured by reducing all samples to a homogeneous state from which the final target material is prepared. Reduced sample is then compressed into tablet form in a cylindrical aluminium cathode before elemental isotope ratio analysis in the AMS.

For example samples obtained from microdosing isotopic carbon labelled library compounds may be converted to graphite, samples obtained from microdosing isotopic halide labelled library compounds may be converted to silver halide salts, samples obtained from microdosing isotopic aluminium labelled library compounds may be converted to aluminium oxide and samples obtained from microdosing isotopic calcium labelled library compounds may be converted to a calcium dihalide or dianhydride. Conversion is for example performed for carbon samples (containing ¹⁴C) by oxidising to CO₂ before reducing to graphite, commonly by the reduction of the CO₂ by hydrogen or zinc over an iron or cobalt catalyst or binder (Vogel J S (1992) Rapid production of graphite without contamination for biomedical AMS, Radiocarbon, 34, 344-350). Oxidation is in a sealed tube which is heated in a furnace at temperatures of up to 900 C. with an oxidant such as copper oxide for approx 8 hours. The resulting CO₂ is reduced to graphite in a second step after cryogenic transfer using a reducing agent such as zinc and titanium hydride and cobalt as a catalyst at temperatures up to about 500 C. for approx 18 hours with cooling. Cobalt/graphite is then compressed into tablet form in a cylindrical aluminium cathode before elemental isotope ratio analysis in the AMS.

Alternatively sample preparation may be for example by the improved technique of WO 01/59476, the contents of which are incorporated herein by reference. Preferably according to the method of WO 01/59476 sample is homogeneously mixed with a binder which is preferably electrically conductive and may be any substance which allows the mixture of sample and binder to be compressed into tablet form. More preferably the binder is one or a mixture of any of graphite, cobalt or aluminium powder, for example where the isotope to be detected is ¹⁴C, or is one or a mixture of any or aluminium oxide and iron or iron oxide, for example where the isotope to be detected is plutonium.

Preferably the method of the invention comprises in a further stage analysing the results of AMS detection and identifying one or more candidate compounds characterised by a desired metabolic profile in a desired subject and forwarding the identified candidate compound(s) for further studies on medical acceptability or efficacy.

In a further aspect of the invention there is provided a method for AMS detection of isotope obtained from one or more radioisotope labelled compounds present in samples of fluids taken from one or more human, animal or plant subjects dosed with one or more candidate compounds identified from a library as hereinbefore defined.

In a further aspect of the invention there is provided the use of a library, a solid support comprising radioisotope labelled compound or a method as hereinbefore defined in (bio)medical, agrochemical, environmental and like screening for further study by AMS detection.

Preferably wherein (bio)medical screening is for compound activity, reactivity such as binding, inhibitory effect or other functionality, to assess for metabolism characteristics; agrochemical screening is for compound activity, reactivity such as binding, inhibitory effect or other functionality, and assessing for plant, insect or like metabolism; environmental screening is for compound activity, reactivity such as binding, inhibitory effect or other functionality, and assessing for soil, aqueous or sediment absorption or adsorption, diffusion, leaching, metabolism, degradation, dissipation or photolysis study.

The library of the invention is useful in any applications in which compound libraries are currently used, wherein the analysis of radioisotopes facilitates detecting the presence of a compound in a sample, location of a compound for example by origin of sample, or the amount of a compound in any location or sample, using AMS radiodetection techniques. This may be of use during the initial screening of a library of compounds for example indicating successful binding to a desired substrate. Alternatively or additionally the library of the invention may be of use after screening and selection of compounds having a desired activity, for example having a desired binding characteristic, in providing radioisotope labelled samples of selected library compounds, shown in an initial screen of the library to be active compounds, for directly performing further studies requiring the presence of radioisotopes, such as radiodetection of metabolic samples.

Preferably the library of the invention is for use in a method of screening for selecting candidate compounds and providing radioisotope labelled samples of those compounds for determining binding to receptors in cells, animal studies, investigating mechanism of action of metabolites, metabolic studies and the like, in known manner. For example receptor binding may be screened for a number of radioisotopic metabolites and receptor-ligand complexes formed may be harvested and subject to AMS to determine whether radiosotope is present indicating receptor binding by the library metabolite in question; or a screen may be conducted for selecting candidate compounds for medical applications and dosing, preferably by microdosing, the candidate compounds in human or animal subjects followed by AMS detection of samples of fluids taken from the subjects to determine metabolism characteristics. The library of the invention is therefore useful in providing in vivo metabolic data relating to metabolism characteristics for the candidate compounds in a modular approach, without the need for intermediate determination of candidate and its synthesis, and synthesis of a radioisotope labelled analogue.

The invention is now illustrated in non limiting manner with reference to the following examples and Figures wherein:

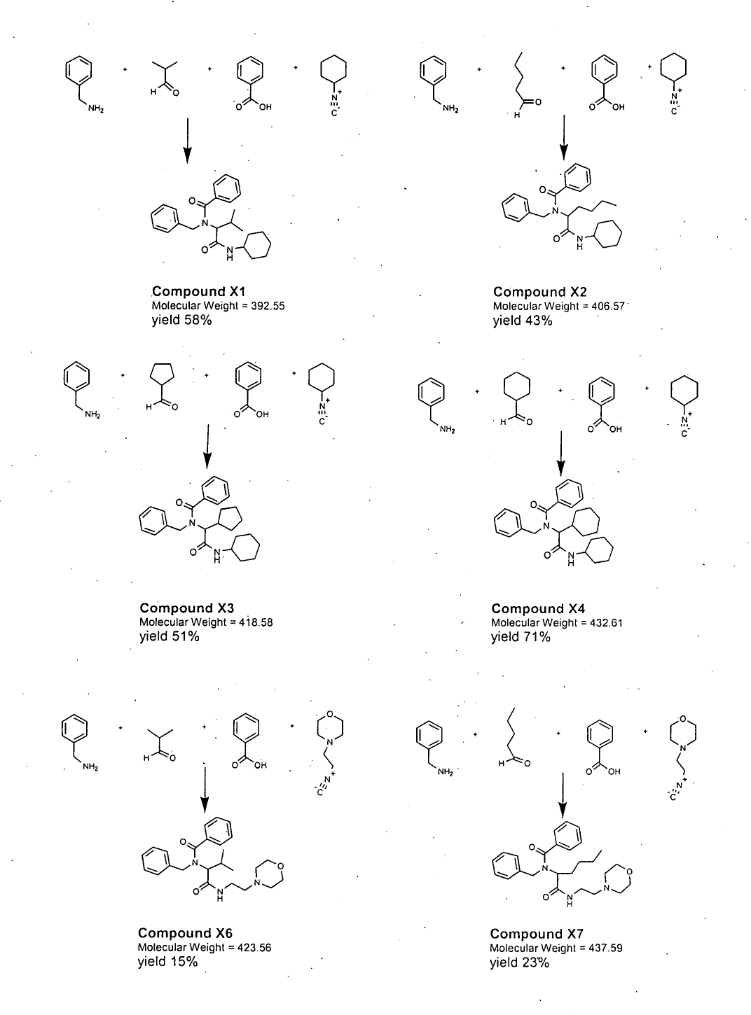

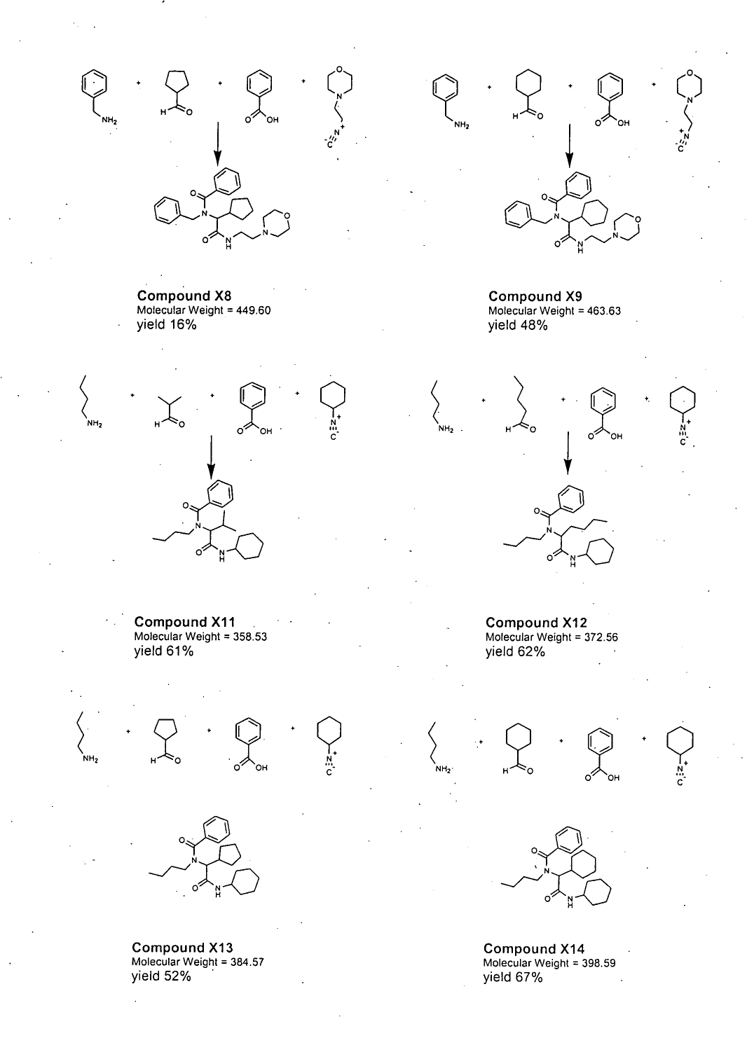

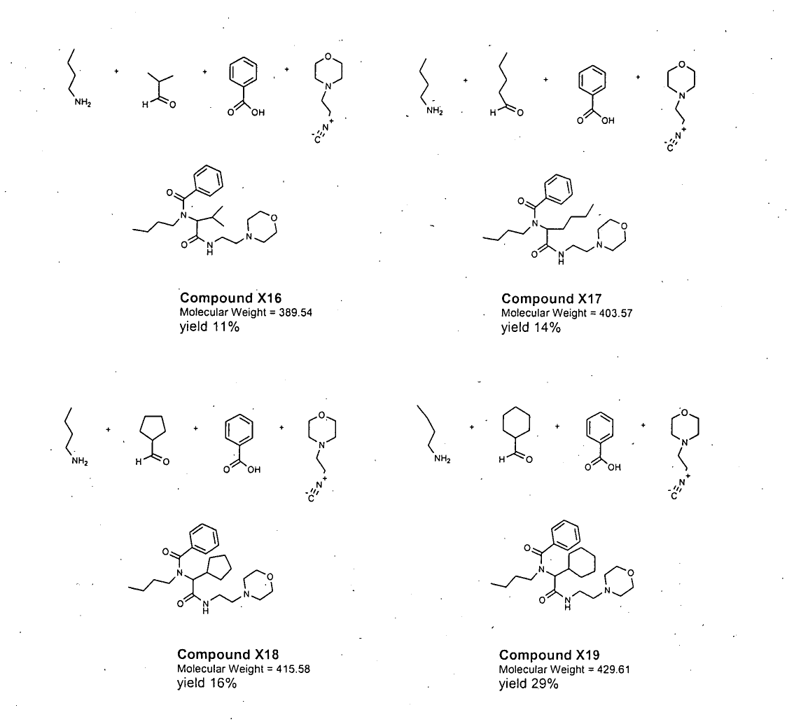

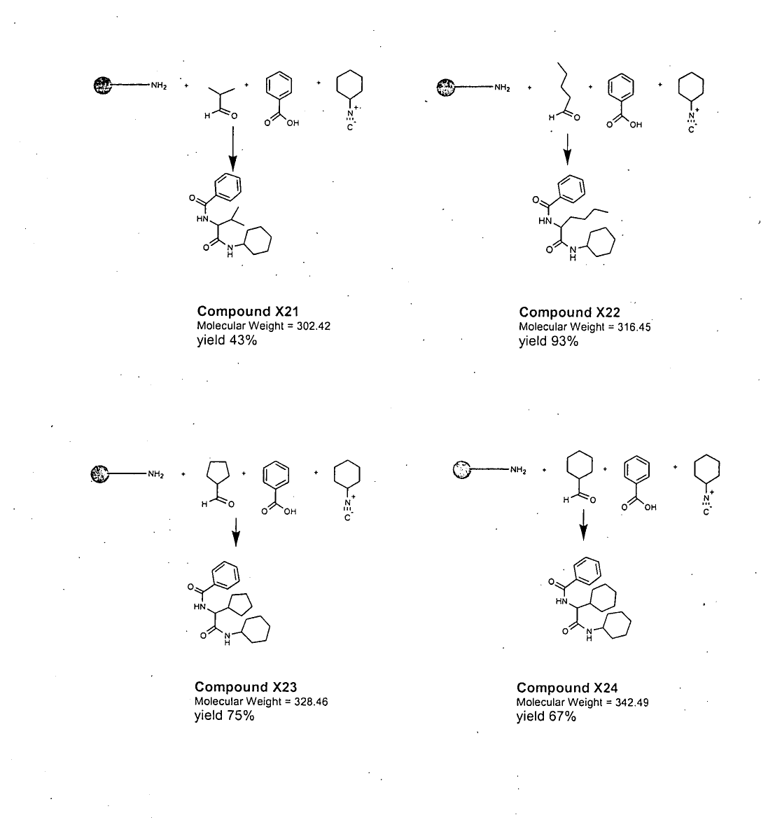

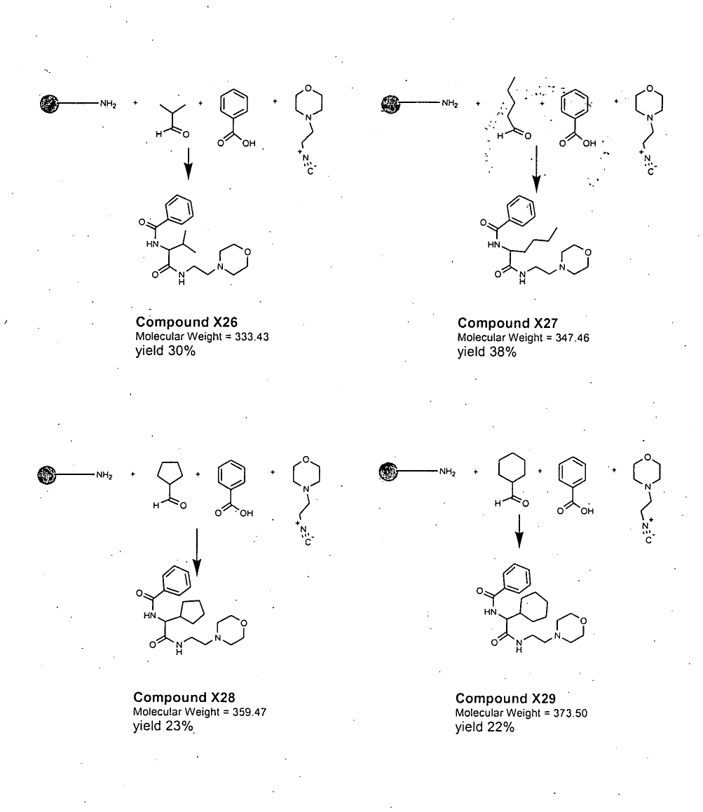

FIGS. 1 to 5 show reaction schemes and structures of library compounds.

### EXAMPLE 1

### Synthesis of Solution Phase/Solid Phase Library Incorporating Trace Levels of ¹⁴C Ring Labelled Benzoic Acid

A classical example of the production of a chemical library is illustrated by the Ugi reaction (Cao, X., Moran, E. J., Siev, D., Lio, A., Ohashi, C. and Mjalli, A M M (1995). Bioorg and Med Chem Lett 5 2953-2958 and Nakamura, M., Inoue, J. and Yamada, T. (2000) Bioorg and Med Chem Lett 10 2807-2810). The reaction, which can be conducted in liquid or on immobilised resin, consists of the condensation of four reactants, in the current case a carboxylic acid, an amine, an aldehyde and an isocyanide. The end products (ie library compounds) are varied by selection of different reactants.

Following some exploratory experiments, the reactant mixtures were used as described in Table 1. Reactions x1-x19 were conducted in solution. Reactions x21-x29 were conducted using TentaGel S-RAM resin. This solid support donates amine groups into the reaction.

TABLE 1
Components used for the Ugi reaction.

| | | | | |
|---|---|---|---|---|
| End | | | | |
| pro- | | | ¹⁴C | |
| duct | | | benzoic | |
| code* | Amines | Aldehydes | acid | Isocyanides |

Solution based reaction

| | | | | |
|---|---|---|---|---|
| x1 | Benzylamine | Isobutyraldehyde | ✓ | Cycohexyl isocyanide |
| x2 | Benzylamine | Valeraldehyde | ✓ | Cycohexyl isocyanide |
| x3 | Benzylamine | Cyclopentane | ✓ | Cycohexyl isocyanide |
| | | carboxaldehyde | | |
| x4 | Benzylamine | Cyclohexane | ✓ | Cycohexyl isocyanide |
| | | carboxaldehyde | | |
| x6 | Benzylamine | Isobutyraldehyde | ✓ | 2-morpholinoethyl |
| | | | | isocyanide |
| x7 | Benzylamine | Valeraldehyde | ✓ | 2-morpholinoethyl |
| | | | | isocyanide |
| x8 | Benzylamine | Cyclopentane | ✓ | 2-morpholinoethyl |
| | | carboxaldehyde | | isocyanide |
| x9 | Benzylamine | Cyclohexane | ✓ | 2-morpholinoethyl |
| | | carboxaldehyde | | isocyanide |
| x11 | Butylamine | Isobutyraldehyde | ✓ | Cycohexyl isocyanide |
| x12 | Butylamine | Valeraldehyde | ✓ | Cycohexyl isocyanide |
| x13 | Butylamine | Cyclopentane | ✓ | Cycohexyl isocyanide |
| | | carboxaldehyde | | |
| x14 | Butylamine | Cyclohexane | ✓ | Cycohexyl isocyanide |
| | | carboxaldehyde | | |
| x16 | Butylamine | Isobutyraldehyde | ✓ | 2-morpholinoethyl |
| | | | | isocyanide |
| x17 | Butylamine | Valeraldehyde | ✓ | 2-morpholinoethyl |
| | | | | isocyanide |
| x18 | Butylamine | Cyclopentane | ✓ | 2-morpholinoethyl |
| | | carboxaldehyde | | isocyanide |
| x19 | Butylamine | Cyclohexane | ✓ | 2-morpholinoethyl |
| | | carboxaldehyde | | isocyanide |

Immobilised based reaction

| | | | | |
|---|---|---|---|---|
| x21 | On resin | Isobutyraldehyde | ✓ | Cycohexyl isocyanide |
| x22 | On resin | Valeraldehyde | ✓ | Cycohexyl isocyanide |
| x23 | On resin | Cyclopentane | ✓ | Cycohexyl isocyanide |
| | | carboxaldehyde | | |
| x24 | On resin | Cyclohexane | ✓ | Cycohexyl isocyanide |
| | | carboxaldehyde | | |
| x26 | On resin | Isobutyraldehyde | ✓ | 2-morpholinoethyl |
| | | | | isocyanide |
| x27 | On resin | Valeraldehyde | ✓ | |
| x28 | On resin | Cyclopentane | ✓ | 2-morpholinoethyl |
| | | carboxaldehyde | | isocyanide |
| x29 | On resin | Cyclohexane | ✓ | 2-morpholinoethyl |
| | | carboxaldehyde | | isocyanide |

*code numbers are not necessarily in numerical order. The end products shown were chosen following preliminary trial experiments and not all reaction mixtures formed the desired product. This is not uncommon with Ugi reactions.

The reactions and end products are shown in FIGS. 1 to 5.

1A—Preparation of Radiolabelled Precursor

The carboxylic acid, which was constant for all reactions, was labelled with ¹⁴C. Non-radiolabelled benzoic acid (ca 1.5 g) was dissolved in hot water along with ca 4,200 dpm of ¹⁴C-ring labelled benzoic acid (Sigma) followed by recrystallisation by cooling (yield ca 97% lightly labelled ¹⁴C ring labelled benzoic acid).

1B—General Procedure for Solution Phase Synthesis

To anhydrous methanol (0.5 ml) was added amine (0.4 mmol) and aldehyde (0.4 mmol). The resulting solution was agitated for 10 min at 28° C. To this solution was added ¹⁴C lightly ring labelled benzoic acid (from 1A) (0.4 mmol) in anhydrous methanol (1 ml) followed by isocyanide (0.4 mmol). The reaction was agitated for 60 h at 28° C. For all reactions except x4 the mixture was evaporated in vacuo and the residue redissolved in ethyl acetate (10 ml) and saturated NaCl (10 mnl), dried over MgSO₄ and filtered. The organic layer was evaporated in vacuo to yield the crude condensation product.

Following completion of the reaction, the products were characterised with mass-spectroscopy (the results are shown in FIGS. 1 to 5) and two compounds (x4 and x22, N-benzyl-N-(cyclohexylcyclohexylcarbamoyl methyl) benzamide and N-(1-cyclohexylcarbamoyl pentyl) benzamide respectively) were characterised by Nuclear Magnetic Resonance Spectroscopy (NMR).

### EXAMPLE 1B

### x4—Synthesis of x4

Using the general procedure of 1B above, to anhydrous methanol (0.5 ml) was added benzylamine (44 microlitre, 0.4 mmol) and cyclohexane carboxaldehyde (48 microlitre, 0.4 mmol). The resulting solution was agitated for 10 min at 28° C. To this solution was added ¹⁴C lightly ring labelled benzoic acid (from 1A) (48 mg, 0.4 mmol) in anhydrous methanol (1 ml), followed by cyclohexylisocyanide (0.4 mmol). The reaction was agitated for 60 h at 28° C., the resulting crude precipitate was filtered, washed with ice-cold methanol and dried under vacuum to yield the crude N-benzyl-N-(cyclohexylcyciohexyl carbamoyl methyl) benzamide (122 mg, 71%).

¹H NMR □(400 MHz, CDCl₃) 7.55-6.85 (m, 10H), 4.67 (d, J 16.2 Hz, 1H), 4.45 (d, J 16.2 Hz, 1H), 4.17 (d, J 9.5 Hz, 1H), 3.66 (m, 1H), 2.41 (m, 1H), 1.95-1.45 (m, 10H), 1.40-0.85(m, 10H).

¹³C NMR □(400 MHz, CDCl₃) 24.6, 25.5, 25.7, 25.7, 26.3, 29.7, 30.2, 32.6, 32.9, 36.1, 47.7, 52.9, 66.7, 126.6, 127.2, 127.4, 128.2, 128.4, 129,6, 136.7, 137.0, 169.2, 174.0

m/z (CI) 433 (M+H⁺); (found 433.2853, C₂₈H₃₇N₂O₂ requires for M+H⁺, 433.2855)

1C—General Procedure for Solid-Phase Synthesis

Rink resin (1.1 mmol 0.055 g) was deprotected with 20% piperidine in dichloromethane (DCM) (3×1 ml). The resin was swelled in 50% DCM:MeOH (1 ml) for 30 min. Aldehyde (10 equiv. based on the initial resin loading) was added to the pre-swelled resin and the reaction mixture was agitated for 10 min at 28° C. ¹⁴C lightly ring labelled benzoic acid (from 1A) (10 equiv.) and isocyanide (10 equiv.) were added and resin was agitated for 36 h at 28° C. The resin was washed with DCM (10×5 ml) and dried under vacuum. The resin was cleaved with 30% TFA:DCM (1 ml) for 3 h. Resin was removed by filtration and the filtrate was concentrated under reduced pressure to yield the crude condensation product.

### EXAMPLE 1C

### x22—Synthesis of x22

Using the general procedure of 1C above, rink resin (1.1 mmol 0.055 g) was deprotected with 20% piperidine in dichloromethane (DCM) (3×1 ml). The resin was swelled in 50% DCM:MeOH (1 ml) for 30 min. Valeraldehyde (64 microlitre, 10 equiv. based on the initial resin loading) was added to the pre-swelled resin and the reaction mixture was agitated for. 10 min at 28° C. ¹⁴C lightly ring labelled benzoic acid (from 1A) (73 mg, 10 equiv.) and cyclohexylisocyanide (76 microlitre, 10 equiv.) were added and resin was agitated for 36 h at 28° C. The resin was washed with DCM (10×5 ml) and dried under vacuum. The resin was cleaved with 30% TFA:DCM (1 ml) for 3 h. Resin was removed by filtration and the filtrate was concentrated under reduced pressure to yield crude N-(1-cyclohexylcarbamoyl pentyl) benzamide (17.9 mg, 94%).

¹H NMR □(400 MHz, CDCl₃) 7.82 (d, J 7 Hz 2H), 7.54-7.42 (m, 3H), 6.61(d, J 8 Hz, 1H), 4.63 (ddd, J 7,7,8 Hz), 3.77 (m, 1H), 2.0-1.5 (m, 6H), 1.4-1.1 (m, 9H), 0.92-0.89(m, 3H)

¹³C NMR [symbol] □(400 MHz, CDCl₃) 13.9, 22.4, 24.7, 25.4, 27.7, 32.3, 32.6, 32.8, 48.8, 53.9, 127.2, 128.6, 132.0, 133.4, 167.6, 171.3. 117

m/z (CI) 317 (M+H⁺); (found 317.2227, C₁₉H₂₉N₂O₂ requires for M+H⁺, 317.2229)

### EXAMPLE 2

### AMS Analysis of Library Samples

A sample of the ¹⁴C-benzoic acid precursor used in Example 1 and samples of x4, x12, x19 and x22 obtained in Example 1 were graphitised using the method of Vogel (Vogel J S (1992) Radiocarbon 34, 344-350) and analysed using a NEC 15SDH-2 Pelletron AMS system. The terminal voltage was 4.5 MV with a particle energy of approximately 22.5 MeV. At the central terminal electrons were stripped from the carbon atom to yield positively. charged carbon ions (^{12, 13, 14}C^{+1 to +6}) C⁴⁺ ions were selected for measurement as these are the most abundant at this energy.

The specific activity of the benzoic acid starting material was 1.56 dpm/mg. The specific activities of the library compounds analysed were as shown in Table 2.

| Compound | Specific activity (dpm/mg) |
|---|---|
| x4 | 0.58 |
| x12 | 0.20 |
| x19 | 0.25 |
| x22 | 0.26 |

Thus all the library compound were all lightly labelled with ¹⁴C. The output of an AMS is in units of “Percent Modern Carbon” (pMC). The mean background value was 2.37 pMC. Compounds X4 to X22 gave pMC values of approximately 2500, 3200, 2200 and 800 respectively. Thus although the specific activities shown in Table 2 were low, they are well within the limits of AMS measurement.

This indicates that the library compounds would be suitable for microdosing to a subject in known manner to determine ADME and PK for each compound.

### EXAMPLE 2

A library of compounds having potential activity as antibacterials or bacteriophages are commercially available. 10 mg of each compound are lightly radio labelled by substitution with ¹⁴C to give a radioisotope labelled library according to the invention. In this case the library is small and the compound in each case is present in an independent vial labelled by library serial number and reference and the identity in each case is known by crossing the library serial number and reference with a library catalogue.

Compounds are screened to detect binding to a receptor molecule associated with the Salmonella microsome, using the Salmonella microsome assay (Ames test). From the results a selection of candidate positive compounds is made.

Candidate library compounds are already radioisotope labelled and may therefore be forwarded directly for microdosing and AMS. The candidate compounds are first made up in a form for microdosing each to a different human subject, in an amount of 5 microgram per subject. After several months samples of blood and urine are taken from each subject and marked with the candidate library compound serial number. Samples are prepared for AMS as known in the art. AMS is performed and results are analysed to indicate the metabolic characteristics of each candidate library compound. From these a selection is made of candidates to forward for Stage I clinical trials, based on acceptable PK characteristics.

### EXAMPLE 2

In this case a library of recombinant human antibodies is ¹⁴C labelled biosynthetically using pooled essential ¹⁴C-amino acids. Sufficient radioactivity is incorporated to permit high limit of detection (several thousand fold increase over ELISA 1.o.d) using AMS. The library is screened for activity of individual radioisotope labelled library antibodies, by testing for receptor binding in a suitable receptor binding assay and a selection is made for PK analysis. Microdosing is carried out using prepared AMS samples of the selected candidate library antibodies using the method of Example 1, and studies are conducted in human serum spiked with the antibody and with rats administered the antibody. The method of the invention takes from 6 weeks to prepare the radioisotope labelled library (fairly independent on size of library in this case as compounds may be radioisotope labelled in parallel by the biosynthetic means described) and screen, identify candidate compounds and conduct the AMS.

In a particular advantage, preclinical toxicology and clinical phase trials may be performed on a candidate radioisotope labelled library compound of the invention, identified by the method of the invention. The entire process to completing clinical phase trials can be carried out in 12 to 16 weeks.

The advantages of the radio labelled library of the invention and its use in the modified screening method of the invention are that the candidate compound is synthesised only once in a microscale amount, there is no delay between screening and microdosing, shortening the time scale to identify an active drug candidate which offers the optimum PK characteristics for example, and therefore there is a greater certainty for start up and multinational drug discovery groups and investment companies alike in basing a business plan around a candidate compound as a prospective pharmaceutical.

1-29. (canceled)

30. Library of compounds or their pharmaceutically acceptable salts, provided as an array of compounds suitable for use in high throughput screening providing for in vitro activity, reactivity, inhibition or functionality screening and selection of compounds and in providing binding data for the selected candidate compounds, by means of AMS which can detect and quantify with relatively short analytical times, levels of radioactivity that are so low that the dose needed to be administered to a human subject falls below the stipulated levels of radioactivity which require regulatory review, each compound being associated with information on its chemical identity and structure, wherein the library comprises a plurality of compounds or their pharmaceutically acceptable salts of formula I: 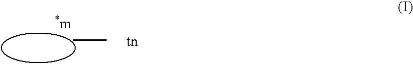
wherein each 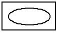
is different and is a compound which comprises an AMS active radioisotope *;
m is a value for the percent incorporation of radioisotope which is a measure of maximum specific activity, wherein 100% incorporation is defined as the incorporation of one radioisotope per molecule, taking a given amount of substance, in which every molecule has one specified atom replaced with its radioactive equivalent ; and
t is a tag associated with information on the compounds chemical identity and structure wherein n is 0, or a whole number integer wherein m is in the range from in excess of zero to 0.1% whereby each compound of formula I is lightly labelled, a proportion thereof having no radioisotope, characterised in that the library is a chemical library.

31. Library as claimed in claim 30 for use in candidate compound selection, detecting the amount of compound and optionally the location in a sample from screening, using AMS radiodetection techniques.

32. Library as claimed in claim 30 wherein an array is a screening plate, microtiter plate, cell array, vial or bottle array, support matrix or plate or fibre optic array.

33. Library as claimed in claim 30 wherein an array is a spatial array, wherein compounds are distributed over a honeycomb plate, with each well in the honeycomb having 0 or 1 compound.

34. Library of compounds as claimed in claim 30 wherein percent incorporation (m) is in the range 1×10⁻¹² to 0.1%.

35. Library as claimed in claim 30 wherein an AMS active radioisotope is selected from any one or more of ²H, ³H, the isotopes of Ba, ¹⁰Be, ¹⁴C, ¹⁷O, ¹⁸O, ²⁶Mg, ²⁶Al, ³²Si, ³⁶Cl, ⁴¹Ca, ⁵⁵Fe, ⁵⁷Fe, ⁶⁰Fe, ⁵³Mn, ⁵⁵Mn, ⁷⁹Se and ¹²⁹I, ²³⁶U and ²³⁹Pu.

36. Library as claimed in claim 35 wherein an AMS active radioisotope is a ¹⁴C radioisotope, optionally additionally a ³⁶Cl or ³H radioisotope.

37. Library as claimed in claim 30 comprising compounds in quantities of nanomoles or millimoles, typically milligrams, by virtue of the sensitivity of AMS detection techniques.

38. Process for the preparation of a library of compounds as claimed in claim 30 comprising AMS active radioisotope labelling a plurality of compounds, each compound being associated with information on its chemical identity and structure wherein labelling is conducted as part of any single or multistep synthetic route which comprises labelling a synthetic precursor or intermediate, determining the specific activity thereof, determining the desired specific activity to give a desired percent incorporation, and combining with a sufficient amount of corresponding unlabeled synthetic precursor or intermediate and isolating as a homogeneous product having desired percent incorporation.

39. Method for selecting one or more candidate compounds comprising high throughput screening a library of the invention comprising AMS active radioisotope labelled compounds as hereinbefore defined in claim 30 and obtaining samples from the screen, and performing AMS detection of the samples and thereby detecting and quantifying the amount and optionally the location of candidate compound in each sample.

40. Method as claimed in claim 39 comprising providing in vitro activity, reactivity, inhibition or functionality screening and selection of compounds and in providing binding data for the selected candidate compounds.

41. Method as claimed in claim 39 wherein a sample for AMS detection is derived from a screen, such as a cell or cell membrane sample.

42. Method as claimed in claim 39 wherein screening is a human or animal biomedical assay or the like, for example a protein binding assay, such as a receptor binding assay.

43. Method for AMS detection and quantification of AMS active radioisotope obtained from one or more radioisotope labelled compounds present in screening samples using the method as claimed in claim 39.

44. Use of a library or a method as hereinbefore defined in claim 30 in (bio)medical, agrochemical, environmental and like screening for further study and quantification by AMS detection.

45. Use as claimed in claim 44 wherein (bio)medical screening is for compound activity, reactivity such as binding, inhibitory effect; agrochemical screening is for compound activity, reactivity such as binding, inhibitory effect or assessing for plant, insect or like metabolism; environmental screening is for compound activity, reactivity such as binding, inhibitory effect or other functionality, and assessing for soil, aqueous or sediment absorption or adsorption, diffusion, leaching, metabolism, degradation, dissipation or photolysis study.

46. Use as claimed in claim 44 for detecting the amount of a compound in any location or sample, using AMS radiodetection techniques.
